(19) United States
(12) Patent Application Publication
(10) Pub. No.: US 2003/0047673 A1
(43) Pub. Date: Mar. 13, 2003

(54) Harmonic suppressing photodetector array

(75) Inventors: William G. Thorburn, Whitinsville, MA (US); Bruce A. Horwitz, Newton, MA (US)

Correspondence Address: HALE AND DORR, LLP, 60 STATE STREET, BOSTON, MA, 02109

(73) Assignee: MicroE Systems, Natick, MA (US)

(21) Appl. No.: 10/217,662

(22) Filed: Aug. 13, 2002

Related U.S. Application Data
(60) Provisional application No. 60/316,121, filed on Aug. 30, 2001.

(51) Int. Cl. G01D 5/34

(52) U.S. Cl. 250/231.13

(57) ABSTRACT

The disclosed optical detector array includes a plurality of photodetectors and is useful for monitoring a signal that includes a first periodic component and a second periodic component. The second periodic component is characterized by a period T. Each of the photodetectors in the array is characterized by a length and a width. The width of each photodetector is substantially equal to an integer multiple of T.

### REFERENCE TO RELATED APPLICATIONS

This application is a Non-Provisional Application of Provisional Application Serial No. 60,316,121 which is related to copending U.S. Patent Application Serial No. 60/316,160 entitled REFERENCE POINT TALBOT ENCODER [Attorney Docket No. MCE-019 (111390-141)] which is assigned to the assignee of the present invention and was filed contemporaneously with the present application. That application is incorporated herein in its entirety by reference.

### BACKGROUND OF THE INVENTION

The present invention relates to an improved optical detector array, or photodetector array. More specifically, the present invention relates to an optical detector array for monitoring periodic signals.

Several varieties of optical encoders for measuring the spatial position of an optical detector array relative to an optical grating are known and are described, for example, in U.S. Pat. Nos. 5,559,600 (Mitchell); 5,486,923 (Mitchell); 5,646,730 (Mitchell); and 5,991,249 (Lee). In such encoders, light incident on an optical grating generates a plurality of diffracted beams. These diffracted beams optically interfere with one another and generate a periodic optical fringe pattern, or optical interference pattern, that is incident on an optical detector array. Relative movement between the grating and the detector array changes the phase angle of the fringe pattern incident on the detector array. Encoders monitor this phase angle and, in response, generate signals representative of the spatial position of the detector array relative to the grating.

FIGS. 1A-1D illustrate a sinusoidal fringe pattern 10 incident on a prior art detector array 20. In the figures, the sinusoidal curve 10 represents the intensity of light incident on the detector array 20. The principal function of the detector array 20 is to measure (or monitor, or detect) the phase angle (or offset) between the pattern 10 and the array 20. Since the fringe pattern 10 is sinusoidal, any point of pattern 10 may be assigned an angle between zero and 360 degrees. For example, the maximum peaks are all at 90 degrees and the minimum peaks are all at 270 degrees. The phase angle (or offset) between the pattern 10 and the array 20 is simply defined by the angular location of the portion of the pattern 10 that intersects a reference location on the detector array 20. If the reference location is taken to be the left edge of the detector array 20, then the phase angle between pattern 10 and array 20 illustrated in FIG. 1A is zero degrees (i.e., because zero degrees of pattern 10 is incident on the left edge of the array 20). Similarly, the phase angles between pattern 10 and array 20 illustrated in FIGS. 1B, 1C, and ID are equal to 90, 180, and 270 degrees, respectively.

In general, movement, in a left or right direction, of the fringe pattern 10 relative to the detector array 20 corresponds to a change in the phase angle between the pattern 10 and the array 20. As discussed above, in an optical encoder, movement of the diffraction grating relative to the detector array causes a change in the phase angle between the fringe pattern and the detector array. Accordingly, the encoder can monitor position of the grating relative to the array by monitoring this phase angle.

One popular algorithm for processing the signals generated by optical detector arrays is known as the “N-bin” algorithm, which is described, for example, in de Groot (1995) [de Groot, Peter, “Derivation of algorithms for phase-shifting interferometry using the concept of a data sampling window,” Applied Optics, vol. 34, p.4723, (1995)]. Use of the N-bin algorithm requires the detector array to include at least N photodetectors (e.g., the 4-bin algorithm requires the array to include at least four photodetectors). The photodetectors are positioned on the array so that the nth photodetector is located at (n)(360/N) degrees, for all n from zero to N-1 (e.g., for the 4-bin algorithm, the photodetectors are located at 0, 90, 180, and 270 degrees).

The prior art detector array 20 shown FIGS. 1A-1D is configured for use with the 4-bin algorithm. Array 20 includes a plurality of photodetectors that have been arranged into groups of four. Each group contains four photodetectors 32, 34, 36, 38. In the group at the left end of the array 20, the photodetector 32 may be said to be “located at” a phase angle of zero degrees. Similarly, in that group the photodetectors 34, 36, and 38 may be said to be “located at” phase angles of 90, 180, and 270 degrees, respectively. Some prior art detector arrays are disclosed for example in U.S. Pat. No. 5,530,543 (Hercher).

It will be appreciated that in the parlance of detector arrays, the term “phase angle” can be used to refer to two different concepts. As discussed above, one use of the term “phase angle” refers to the offset between a detector array and the fringe pattern being monitored by the array (e.g., in FIG. 1B, this phase angle is equal to 90 degrees). Another use of the term “phase angle” refers to locations, or distance measurements, on the detector array. For example, in the detector array 20 shown in FIGS. 1A-1D, the detector 32 at the left end of the array “extends horizontally from” zero degrees to ninety degrees, and the left edge of the adjacent detector 34 is “located at” ninety degrees. Saying that detector 32 extends horizontally from zero to ninety degrees is equivalent to saying that the width of the detector 32 is equal to one quarter of a period T of the fringe pattern 10 (i.e., detector width equals (¼)*T). Similarly, saying that the left edge of a detector is at 450 degrees (as shown in FIGS. 1A-1D) is equivalent to saying that the distance between the left edge of that detector and the left edge of the array 20 is equal to one and one fourth times the period T of the fringe pattern 10 being detected by the array (i.e., distance equals 1.25*T). Once the location of any photodetector in an array has been assigned to a reference location phase angle (e.g., such as zero degrees), the locations of all the other photodetectors may then be specified in terms of phase angles, and each phase angle represents a measurement of distance quantized into units of the period of the signal being monitored. Also, whereas the left edges of the photodetectors were used in the example above to determine the locations of the photodetectors, it will be appreciated that any method that is consistently applied to all photodetectors may also be used (e.g., the centers of the photodetectors could be used instead of the left edges).

The N-bin algorithm may be described generally by the following Equation (1).

$$Tan ( P ) = \frac{{\sum }_{0}^{N - 1} W {sin}_{n} * {S}_{n}}{{\sum }_{0}^{N - 1} W {cos}_{n} * {S}_{n}} \qquad ( 1 )$$

In Equation (1), Sₙ is the output of the nth photodetector in the array, Wsinₙ is the nth “sine weight”, Wcosₙ is the nth “cosine weight”, and P is the phase angle between the detector array and the incident fringe pattern. The sine and cosine weights, Wsinₙ and Wcosₙ, are specified by the algorithm and vary depending on the value of N. In the 4-bin algorithm, computation of the phase angle P is relatively simple and Equation (1) reduces to Tan(P)=(S₀−S₂)/(S₁−S₃).

FIGS. 1A-1D generally represent prior art detector arrays constructed for use with the 4-bin algorithm. In such detector arrays, each photodetector is typically about 90 degrees wide. That is, a detector that starts at zero degrees extends from zero to nearly 90 degrees, a detector that starts at 90 degrees extends from 90 to nearly 180 degrees, a detector that starts at 180 degrees extends from 180 to nearly 270 degrees, and a detector that starts at 270 degrees extends from 270 to nearly 360 degrees. Such an arrangement effectively packs adjacent detectors as closely together as possible and collects the maximum amount of light incident on the detector array.

Typically, detector arrays constructed for use with the N-bin algorithm include more than N photodetectors. Including more than N photodetectors is popular because it increases the signal to noise ratio for the detector array. For example, a detector array constructed for use with the 4-bin algorithm may include forty photodetectors: photodetectors located at 0+j360, 90+j360, 180+j360, and 270+j360 degrees for all integer values of j between zero and nine. In this example, the value of S₀ for use in Equation (1) would be generated by summing the outputs of the photodetectors located at 0+j360 for all integer values of j from zero to nine. In the general case, a detector array constructed for use with the N-bin algorithm includes N*J photodetectors and the photodetectors are located at (n)(360/N)+j360 for all integer values of n between zero and N−1 and all integer values of j between zero and J−1, and the value Sₙ for use in Equation (1) is generated by summing the output of the J photodetectors located at n(360/N)+j360 for all integer values of j between zero and J−1.

The N-bin algorithm performs optimally when the periodic optical fringe pattern incident on the detector array is a sinusoidal signal. As is well known, intersecting beams of light generally generate a periodic optical fringe pattern. Interference between positive and negative first order diffracted beams in an optical encoder generate a sinusoidal fringe pattern. However, one problem with optical encoders is that the fringe patterns incident on their detector arrays are generally not purely sinusoidal. One reason the fringe patterns are not sinusoidal is that, in addition to the first order diffracted beams, the optical grating also generates higher order diffracted beams. Incidence of these higher order beams on the detector array tends to make the fringe pattern less sinusoidal and more like a square wave. In general, presence of the higher order beams reduces the accuracy of the encoder.

One known method for reducing contribution of unwanted higher order beams is to restrict the location of the detector array to regions of “natural interference” in which higher order beams are not present. However, this can increase the mechanical complexity of the encoder. Accordingly, there is a need for improved methods of filtering the contribution of unwanted higher order beams in optical encoders.

### SUMMARY OF THE INVENTION

These and other objects are provided by an improved detector array. Detector arrays constructed according to the invention accurately monitor the phase angle between the array and a periodic component of interest incident on the array while simultaneously suppressing (or filtering) the effect of a periodic noise component also incident on the array.

Detector arrays constructed according to the invention include a plurality of photodetectors arranged into groups. Each group provides a set of non-degenerate samples of the component of interest sufficient to permit computation of the phase angle. The arrays may also include additional groups of photodetectors, and inclusion of such additional groups may boost the signal to noise ratio.

The effects of a periodic noise component may be suppressed according to the invention by setting the widths of the photodetectors substantially equal to an integer multiple of the period of the noise component. Such a selection of width may often make it inconvenient to place all photodetectors of a group into a region no wider than a single period of the component of interest. In such cases, the periodicity of the component of interest is preferably exploited and the photodetectors in the group are located in a region wider than one period of the component of interest.

Still other objects and advantages of the present invention will become readily apparent to those skilled in the art from the following detailed description wherein several embodiments are shown and described, simply by way of illustration of the best mode of the invention. As will be realized, the invention is capable of other and different embodiments, and its several details are capable of modifications in various respects, all without departing from the invention. Accordingly, the drawings and description are to be regarded as illustrative in nature, and not in a restrictive or limiting sense, with the scope of the application being indicated in the claims.

### BRIEF DESCRIPTION OF THE FIGURES

For a fuller understanding of the nature and objects of the present invention, reference should be made to the following detailed description taken in connection with the accompanying drawings in which the same reference numerals are used to indicate the same or similar parts wherein:

FIGS. 1A, 1B, 1C, and 1D illustrate a periodic optical signal incident on a prior art detector array in which the phase angle between the signal and the array is zero, 90, 180, and 270 degrees, respectively.

FIG. 2A is a graph showing the intensity of a light signal including a first and a third order component.

FIG. 2B is a graph showing the intensity of the first and third order components that, when summed, yield the signal shown in FIG. 2A.

FIG. 2C shows a photodetector constructed according to the invention so as to be insensitive to the third order component shown in FIG. 2B.

FIG. 3 shows a perspective view of a detector array constructed according to the invention.

FIG. 4 illustrates how selection of photodetector width according to the invention may make it impractical to locate a group of non-overlapping photodetectors that provide the desired number of non-degenerate samples within a region no wider than a single period of the component of interest.

FIG. 5A shows a side view of an optical encoder constructed according to the invention.

FIG. 5B shows a top view of the sensor head of the encoder taken in the direction of arrow 5B-5B as shown in FIG. 5A.

FIG. 5C shows a view of the scale of the encoder taken in the direction of arrow 5C-5C as shown in FIG. 5A.

FIG. 6 illustrates how the photodetectors of the array shown in FIG. 3 may be arranged into groups.

FIG. 7 shows another detector array constructed according to the invention.

FIG. 8 shows yet another detector array constructed according to the invention.

FIG. 9 shows still another detector array constructed according to the invention.

FIG. 10 shows yet another detector array constructed according to the invention.

FIG. 11 shows still another detector array constructed according to the invention.

FIG. 12 shows yet another detector array constructed according to the invention.

FIG. 13 illustrates analog circuitry that may be used to calculate signals input to the 4-bit algorithm from the array shown in FIG. 12.

FIGS. 14A-14C illustrate optical fringes incident on a detector array.

### DETAILED DESCRIPTION OF THE PREFERRED EMBODIMENTS

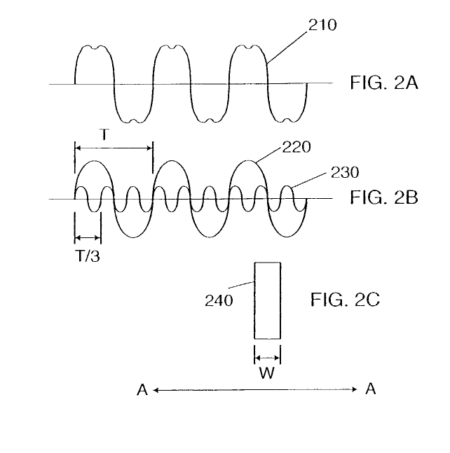

FIG. 2A illustrates schematically a periodic optical fringe pattern 210. As shown in FIG. 2B, pattern 210 may be decomposed into two patterns: a first order, or fundamental, fringe pattern 220 and a third order fringe pattern 230. As shown, the period of third order fringe pattern 230 is equal to one third the period of the first order fringe pattern 220. Patterns such as pattern 210 (as shown in FIG. 2A) may be generated by interference between multiple diffracted beams in an optical encoder. As shown, pattern 210 is less sinusoidal, and more like a square wave, than either of patterns 220, 230. When a fringe pattern such as pattern 210 is incident on a detector array, the prior art does not provide an effective way of suppressing the contribution of the unwanted third order pattern 230. The invention provides a method of constructing detector arrays that effectively filter out the contribution of unwanted higher order fringe patterns, such as third order pattern 230.

One preferred way, according to the invention, of filtering out the contribution a higher order fringe pattern is to set the width of each photodetector in the array equal to the period of the higher order fringe pattern. For example, in a detector array constructed according to the invention to suppress the effects of third order fringe pattern 230, the width of each photodetector in the array would be substantially equal to the period of pattern 230. So, in a detector array constructed according to the invention to suppress effects of third order fringe pattern 230, the width W of each photodetector in the array would be substantially equal to one third of the period of the fundamental frequency (i.e., one third the period of the fundamental fringe pattern 220).

FIG. 2C illustrates this concept. FIG. 2C shows a single photodetector 240. As shown, the width W of photodetector 240 is substantially equal to the period of the third order fringe pattern 230 T/3 (or one third the period of fringe pattern 220). Since the width of photodetector 240 is substantially equal to the period of pattern 230, the same amount of energy from pattern 230 will always be incident on photodetector 240 regardless of how the position of photodetector 240 may be shifted in the directions indicated by arrow A-A. Accordingly, the output generated by photodetector 240 in response to pattern 230 will always be substantially equal to a constant value regardless of the location of photodetector 240 (or regardless of the phase angle between pattern 230 and detector 240). Therefore, the effect of pattern 230 on photodetector 240 may be filtered out simply by subtracting a constant offset value from the output of photodetector 240.

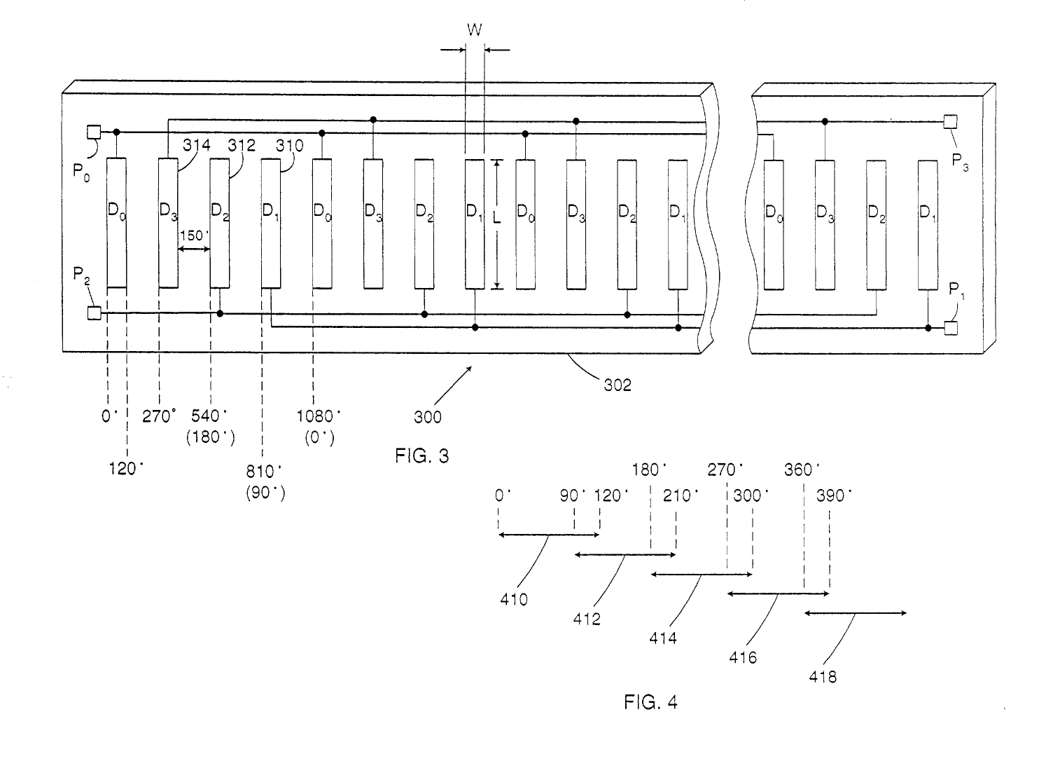

FIG. 3 shows a top view of a detector array 300 constructed according to the invention. As will be discussed in greater detail below, detector array 300 has been constructed according to the invention (1) for use with the 4-bin algorithm; (2) to detect the phase angle of a first order fringe pattern; and (3) to filter out contribution of a third order fringe pattern. In other words, with reference to FIGS. 2A, 2B, and 3, if interference pattern 210 is incident on detector array 300, the detector array 300 will accurately detect the phase angle between first order pattern 220 and array 300 while simultaneously filtering out contribution of third order pattern 230. While construction of detector array 300 will be discussed in detail, it will be appreciated that detector array 300 is merely an example of a detector array constructed according to the invention and that the procedure disclosed herein may be used to design detector arrays for use with other algorithms and for filtering out the contribution of other orders of beams.

Referring to FIG. 3, detector array 300 includes a plurality of photodetectors D₀, D₁, D₂, and D₃, disposed on a substrate 302. Each of the photodetectors generates an output signal in response to incident light. The output terminals of all the D₀ photodetectors are electrically connected to an output pad P₀. So, pad P₀ effectively provides an electrical signal representative of the sum of the analog output signals generated by all the D₀ photodetectors. Similarly, the output terminals of all the D₁, D₂, and D₃ photodetectors are electrically connected to output pads P₁, P₂, and P₃, respectively. So, pads P₁, P₂, and P₃ provide electrical signals representative of the sum of the analog output signals generated by all the D₁, D₂, and D₃ photodetectors, respectively.

As discussed above in connection with Equation (1), the 4-bin algorithm uses four inputs, Sₙ for all integer values of n from zero to three. In operation of detector array 300, the input signal Sₙ is preferably a digital representation of the analog electrical signal present on pad Pₙ, for all values of n from zero to three. Such digital representations may of course be generated by using one or more analog-to-digital converters.

As discussed above in connection with FIG. 2C, one way to effectively filter out contribution of pattern 230 to light incident on a photodetector is to select the width of the photodetector to be substantially equal to the period of pattern 230. This concept is exploited in detector array 300 and the widths W of all the photodetectors are substantially equal to one period of the third order fringe pattern 230. This selection of photodetector width is illustrated by the D₀ photodetector at the left end of the array 300. As shown, the width of that photodetector extends from a reference location of zero degrees to 120 degrees. These numbers of zero and 120 degrees refer to the phase angle of the fundamental fringe pattern 220 (FIG. 2B). An extent of 120 degrees is equivalent to an extent of one third of a period of fundamental fringe pattern 220, and is also equivalent to an extent of one full period of the third order fringe pattern 230. It will be appreciated that assigning the left edge of detector D₀ to correspond to the reference point of zero degrees of phase angle is somewhat arbitrary, however, once that assignment is made, all other angles shown in FIG. 3 are made with respect to this reference point of zero degrees. Selecting the widths of all photodetectors in array 300 to be substantially equal to 120 degrees of fundamental fringe pattern 220 insures that the array will be insensitive to contributions from the third order fringe patter 230.

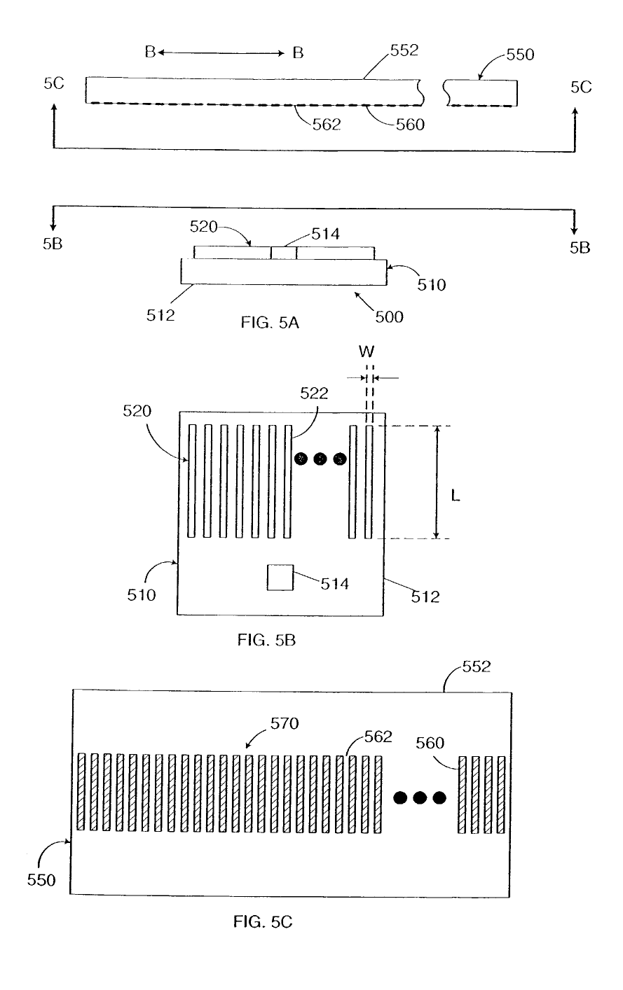

Once the photodetector width has been selected, the next step in designing a detector array according to the invention is to determine where on the array each photodetector should be located. As discussed above, the 4-bin algorithm uses samples from photodetectors located at zero, 90, 180, and 270 degrees. However, the selected width of 120 degrees for the photodetectors makes placement of the photodetectors at these locations difficult. That is, locating four photodetectors at zero, 90, 180, and 270 degrees while also making the width of each photodetector be equal to 120 degrees would require the photodetectors to physically overlap as shown in FIG. 4.

In FIG. 4, arrows 410, 412, 414, 416, 418 represent the widths of photodetectors beginning at zero, 90, 180, 270, and 360 degrees, respectively. Each of the photodetectors is 120 degrees wide. As shown, making each photodetector 120 degrees wide and locating the detectors at these locations would require the photodetectors to physically overlap. While it is possible to design such physically overlapping photodetectors, such a design is more complex than for an array that uses non-overlapping photodetectors.

One way to solve the problem illustrated in FIG. 4 of overlapping photodetectors is to exploit the periodic nature of the optical fringe patterns being detected. For example, since pattern 220 is periodic, a sample of this pattern taken at 90 degrees will be substantially equivalent to a sample taken at 90+n360 degrees for any integer value of n. This concept is exploited in detector array 300 shown in FIG. 3.

To recap, the 4-bin algorithm uses samples taken at zero, 90, 180, and 270 degrees, and it was already decided to make the width of each photodetector equal to 120 degrees to provide the benefit of suppressing the contribution of the third order fringe pattern 230. The photodetector D₀ at the left end of the array provides a sample at zero degrees. To obviate the need for physically overlapping photodetectors, in array 300 (1) the sample at 90 degrees is provided by detector 310 which starts at 810 degrees (or 90+2*360); (2) the sample at 180 degrees is provided by detector 312 which starts at 540 degrees (or 180+360); and (3) the sample at 270 degrees is provided by detector 314 which starts at 270 degrees (or 270+0*360). Additional samples at periodic multiples of 0, 90, 180, and 270 degrees are provided by the photodetectors to the right of photodetector 310.

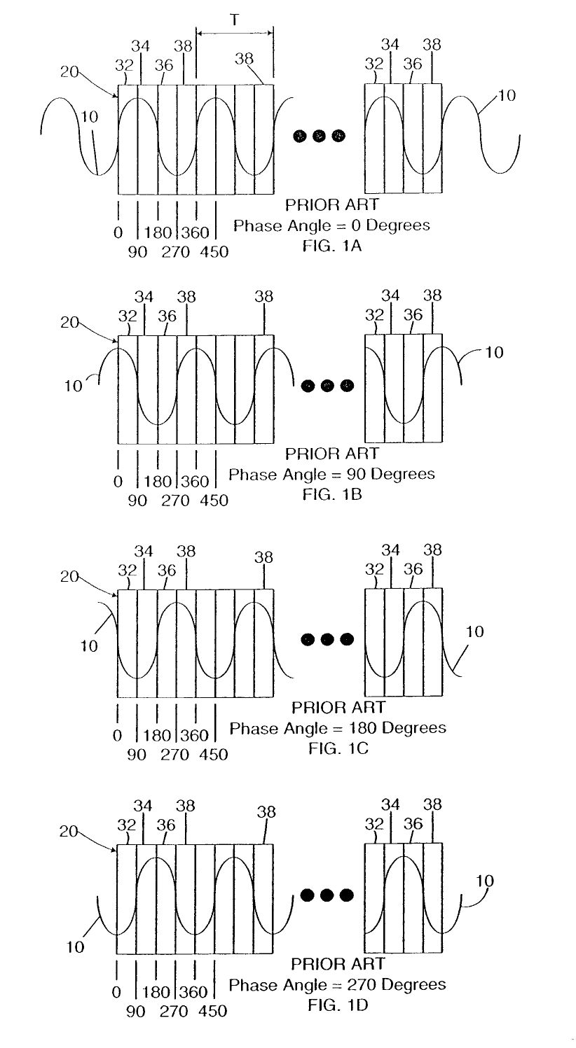

As shown in FIG. 3, each pair of adjacent detectors is separated by a width of 150 degrees. This space between adjacent detectors is “dead space”, and light incident on these dead spaces is not used by detector array 300. Discarding this light could be regarded as wasteful. However, by discarding this light, detector array 300 is able to provide several important advantages. Most importantly, detector array 300 suppresses contribution of the unwanted third order fringe pattern 230. As another example, having a relatively large dead space between two adjacent detectors reduces or suppresses the cross talk between the two detectors. Also, having dead space between adjacent detectors allows each detector to be made as wide as desired. For example, in the prior art detector array 20 shown in FIGS. 1A-1D, it was generally desirable to make each photodetector 90 degrees wide. However, since some dead space generally has to be provided between adjacent photodetectors, the photodetectors in prior art detector array 20 had to be slightly less than 90 degrees wide. In contrast, in array 300, the width of the photodetectors can be made substantially equal to the desired one hundred twenty degrees.

As noted above, U.S. Pat. No. 5,530,543 (Hercher) discloses some prior art detector arrays. Although multi-element photodetector arrays are discussed in the Hercher patent, there is no disclosure of selecting the width of photodetectors within the array so as to suppress a selected harmonic component as is done in array 300.

FIGS. 5A-5C illustrate how a detector array such as array 300 may be used in an optical encoder 500 constructed according to the invention. Such optical encoders are discussed in greater detail in the above-identified U.S. Patent Application Serial No. 60/316,160, entitled REFERENCE POINT TALBOT ENCODER [Attorney Docket No. MCE-019 (111390-141)]. FIG. 5A shows a side view of optical encoder 500 which includes a sensor head 510 and a scale 550. FIG. 5B shows a top view of sensor head 510 taken in the direction indicated by arrow SB-5B in FIG. 5A. FIG. 5C shows a view of scale 550 taken in the direction indicated by arrow SC-SC in FIG. 5A.

Sensor head 510 includes a substrate 512, a light source 514, and a detector array 520. Source 514 and array 520 are mounted on substrate 512. Source 514 may be implemented for example using a Vertical Cavity Surface Emitting Laser (VCSEL). Source 514 is preferably a single mode laser.

Detector array 520 includes a plurality of individual detectors 522 as indicated in FIG. 5B. Array 520 is preferably configured substantially like array 300, which is shown in FIG. 3, for use with the 4-bin algorithm and so as to suppress contribution of a third order fringe pattern. Array 520 is substantially identical to array 300. The principal difference is that, in sensor head 510, in addition to the photodetectors 522 of array 520, the light source 514 is also disposed on the substrate 510. As indicated in FIG. 5A, the upper surface of light source 514 (i.e., the surface from which light is actually emitted) is preferably coplanar with the upper surface of the photodetectors 522 in array 520.

Scale 550 includes a substrate 552 and a series of reflective strips 560, which form a diffraction grating 570. Substrate 552 may be implemented using a block of transparent material (e.g., glass). Strips 560 may be implemented using strips of reflective metal (e.g., chrome) disposed on the lower surface of substrate 552. A region 562 of transparent material is disposed between each pair of adjacent reflective strips 560. In the preferred embodiment, diffraction grating 570 is characterized by a 50-50 duty cycle, meaning that the width of the reflective strips 560 is substantially equal to the width of the transparent regions 562.

In operation, light emitted by source 514 propagates up towards grating 570. Some of the light incident on grating 570 is diffracted down and generates an optical interference pattern that is incident on detector array 520. Movement of scale 550 in the directions of arrow B-B as shown in FIG. 5A causes changes in the phase angle between the detector array 520 and the interference pattern incident on detector array 520. Processing circuitry (not shown) monitors this phase angle and generates a signal representative of the position of scale 550 relative to sensor head 510.

The optical interference pattern incident on detector array 520 is generated by optical interference between the zeroth order, the plus first order, and the minus first order beams diffracted from grating 570 as well as by higher order beams that are also diffracted from grating 570. The fringe pattern generated by interference between the zeroth order, plus first order, and minus first order diffracted beams represents the “signal” that is ideally processed by encoder 500. The higher order beams diffracted from grating 570 represent unwanted noise, or harmonic distortion, and some of this noise is filtered by using detector arrays constructed according to the invention. As discussed in the above identified U.S. Patent Application Serial No. 60,316,160, entitled REFERENCE POINT TALBOT ENCODER [Attorney Docket No. MCE-019 (111390-141)], the presence of the zeroth order beam affects the signal (e.g., by making it less sinusoidal); however, it may be preferable to tolerate the presence of the zeroth order beam principally because it is less expensive to construct an encoder in which the zeroth order is present.

One advantage of implementing grating 570 as a 50-50 duty cycle grating is that even orders of diffraction are eliminated from the light that is diffracted down towards array 520 (or the energy in the even orders of diffracted beams is substantially equal to zero). So, noise from the second order diffracted beams (as well as the 4^{th} order, 6^{th} order, and all other even orders) is substantially eliminated simply by implementing grating 570 as a 50-50 duty cycle grating.

Since the second order beams are substantially eliminated by implementing grating 570 as a 50-50 duty cycle grating, the largest source of noise generated by grating 570 is the third order diffracted beams. However, although the third order diffracted beams are incident on the detector array, the array 520 has been designed (as discussed above, e.g., in connection with FIG. 3), to be insensitive to an incident third order fringe pattern. Since the 4^{th} order beams are also eliminated by selection of grating 570, the largest source of noise in encoder 500 may be regarded as the 5^{th} order beams diffracted by grating 570. It will be appreciated that the amount of energy in the 5^{th} order diffracted beams is relatively small (e.g., about sixty six percent smaller than the energy in the 3^{rd} order diffracted beams), and the amount of noise contributed by the 5^{th} and other higher odd order diffracted beams is also correspondingly relatively small.

In summary, encoder 500 is advantageously characterized by reduced noise. Noise from even order diffracted beams is suppressed by the selection of grating 570. Noise from the third order fringe pattern is suppressed by the design of detector array 520.

In one preferred embodiment of encoder 500, light source 514 emits light having a wavelength of 850 nm, the width of the strips 560 of grating 570 is substantially equal to 10 microns, the spacing between adjacent strips 560 of grating 550 is substantially equal to 10 microns, and the spacing between the scale and the sensor head is substantially equal to 4.7 millimeters. This selection of diffraction grating period and the layout of the encoder generates a first order fringe pattern characterized by a period substantially equal to 40 microns. In this embodiment, the detector array 520 includes 20 photodetectors, the width W of all photodetectors 522 in array 520 is substantially equal to 13.33 microns, and the spacing between adjacent detectors 522 in the array (i.e., the width of the dead space) is substantially equal to 16.67 microns. One preferred choice for the length L of the photodetectors is for the length L to be substantially equal to 360 microns.

The construction of detector array 300 and its use in an optical encoder 500 has been discussed above. The design and construction of detector arrays according to the invention will now be discussed in a more general way. The optical fringe pattern detected by a detector array may generally be regarded as a sum of sinusoids as described in the following Equation (2).

$$S ( x ) = {W}_{0} + {\sum }_{n = 1}^{N} {W}_{n} * sin ( 2 π {f}_{n} x ) \qquad ( 2 )$$

In Equation (2), S(x) represents the light signal incident on the detector array. As shown, S(x) is a sum of sinusoids, or a sum of harmonic components. In Equation (2), Wₙ represents the signal strength, or weight, of the nth harmonic component of S(x), fₙ represents the frequency of the nth harmonic component, and W₀ represents the constant background illumination.

Generally, the first harmonic component of S(x) [i.e., W₁*sin(2πf₁x)] is the component of interest and all the higher order components of S(x) [i.e., Wₙ*sin(2πfₙx) for all integer values of n from 2 to N] are regarded as noise, or harmonic distortion. The principal function of the detector array is to determine the phase angle between the detector array and the component of interest (i.e., normally the first harmonic component). For example, referring back to FIG. 1B, if pattern 10 represented the component of interest, the function of the detector array would be to determine that the phase angle was equal to 90 degrees.

Detector arrays constructed according to the invention are sensitive to the component of interest (i.e., are capable of accurately measuring the phase angle between the detector array and the component of interest) and automatically filter out (or suppress, or are insensitive to) any desired higher order component (i.e., presence of the higher order component does not appreciably degrade the accuracy of the measurement of the phase angle between the component of interest and the detector array). Also, detector arrays constructed according to the invention to filter out any particular harmonic component also filter out multiples of that component (e.g., a detector array that filters out the 4^{th} harmonic component also automatically filters out the 8^{th} and 12^{th} components as well as all other integer multiples of the 4^{th} component).

The design procedure for designing a detector array that filters out the nth harmonic component generally involves two steps. The first step is to choose the width of the photodetectors in the array so that the width of each photodetector substantially equals either the period of the nth harmonic component or an integer multiple of that period. The second step is to then place the photodetectors at appropriate locations within the array so as to allow the array to measure the phase angle between the component of interest and the array (e.g., using the preferred N-bin algorithm).

Regarding the first step, if the period T of the nth harmonic is so small that it is not practical to make photodetectors with width equal to T, the photodetectors may also be made so that their width is substantially equal to 2T, 3T, or any other integer multiple of T. If a photodetector's width is equal to T, then energy from the nth harmonic component incident on the photodetector will always equal a constant value regardless of the phase angle between the photodetector and the component (or regardless of how the photodetector is shifted in the direction of the arrow A-A as shown in FIG. 2C). This is because a single period of the nth harmonic will always be incident on the photodetector. Similarly, if the photodetector's width is equal to 2T, then two periods of the nth harmonic component will always be incident on the photodetector regardless of the phase angle, and again, the energy of the nth harmonic component incident on the photodetector will always be equal to a constant value. When the energy of a harmonic component incident on a photodetector is always equal to a constant, the contribution of that component may be filtered out, or suppressed, simply by subtracting a constant value from the output signal generated by the photodetector.

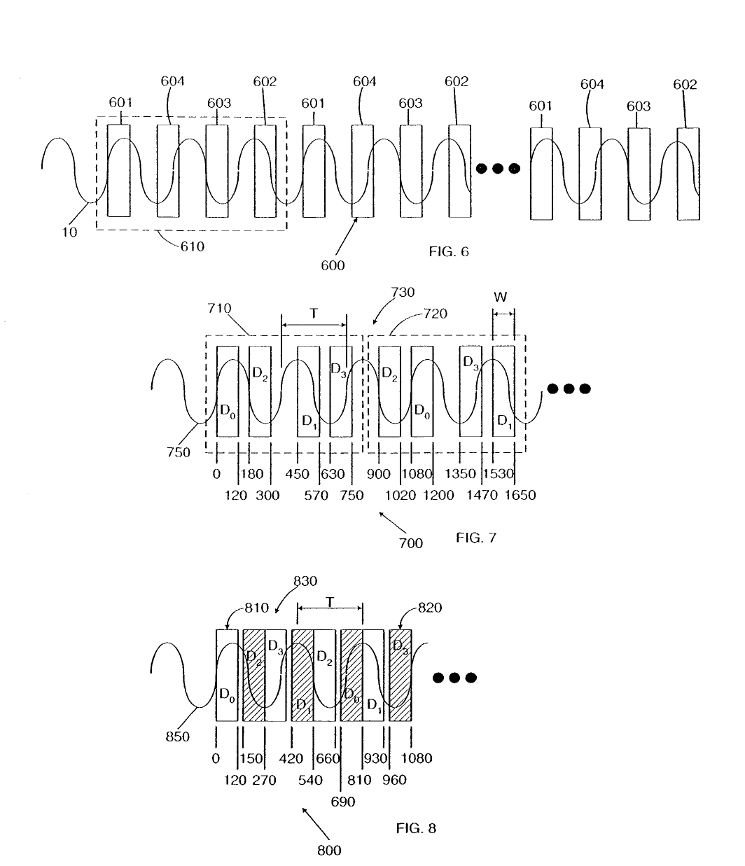

A few additional considerations that may affect the selection of the photodetector width will now be discussed. Photodetector operation will briefly be reviewed with reference to FIG. 6. FIG. 6 shows an array 600, which is substantially similar to array 300. In array 600, all photodetectors are 120 degrees wide and all adjacent photodetectors are spaced apart by 150 degrees of dead space. FIG. 6 also shows a periodic component 10 as being incident on array 600 so that the phase angle between component 10 and array 600 is zero degrees. If the left edge of photodetector 601, at the left end of array 600, is defined to be at a reference location of zero degrees, then the output signal S generated by this detector is given by the following Equation (3).

$$S ∝ {\int }_{0}^{120} sin ( x ) ⅆ x = sin ( 60 ) \qquad ( 3 )$$

S is proportional to an integral of a sinusoid because the intensity of the light signal incident on the photodetector varies sinusoidally and because photodetectors generate an output signal representative of the sum of all the light incident on them. The integral is from zero to 120 degrees because that is the physical extent, or the width, of the photodetector. Further, because of the mathematical properties of sinusoidal signals, the integral of a sinusoid from a starting angle to an ending angle is equal to the sine of the average of the starting and ending angles. So, although the photodetector spans a width of 120 degrees, the actual measurement made by the photodetector is of the sine at a particular angle (i.e., sixty degrees). So, in some sense, the “information” provided by a photodetector when that photodetector is sampling a sinusoidal signal is not a function of the photodetector's width but rather a function of the location of the centerline of the detector.

However, other considerations affect the choice of a photodetector's width. Most importantly, as discussed above, when the signal incident on the photodetector represents a sum of periodic components, selecting the photodetector width to be equal to the period of one of the components makes the photodetector insensitive to that component. Also, even when the incident light is only a single periodic component, considerations of accuracy and signal-to-noise ratio affect the choice of photodetector width. For example, the strength of the signal measured by a detector that is sixty degrees wide will be about sixty times greater than for a detector that is only one degree wide. Although increasing detector width can boost signal strength, care should be taken to not make the detector so wide so as to suppress the very component that is being measured. Preferably, photodetectors in arrays constructed according to the invention are generally not made wider than about two thirds of the period of the component that is being measured.

Once the width of the photodetectors has been selected, the next step is to determine where to place the photodetectors in the array. Before addressing this step directly, the concept of degenerate and non-degenerate samples will be briefly discussed. In general, any two samples taken 360 degrees apart, or integer multiples of 360 degrees apart, are degenerate. Such samples are called “degenerate” because if the signal they are sampling is truly periodic, and if there are no measurement errors, then two or more such samples would provide no more information than a single sample. Any set of samples is non-degenerate if each sample provides information that is not provided by the other samples in the set, even if the signal being sampled is truly periodic and if there are no measurement errors. For example, samples taken at one, two, and ten degrees constitute a non-degenerate set of three samples. Samples taken at zero, 90, and 360 degrees constitute a degenerate set of three samples because the sample at zero degrees is equivalent to the sample at 360 degrees. In general, a set of samples is a non-degenerate set if no two of the samples are taken at integer multiples of 360 degrees of one another.

One decision relevant for designing a detector array is how many non-degenerate samples to use for calculating the phase angle. The N-bin algorithm uses N non-degenerate samples. In addition to specifying the number of non-degenerate samples, the N-bin algorithm also specifies that the samples are equally spaced. So, for example the 4-bin algorithm uses four non-degenerate samples, and those samples are each spaced apart by ninety degrees (i.e., because 4/360=90). Other known algorithms exist that can compute the phase angle from N non-degenerate samples that are not equally spaced. For example, it is mathematically possible to compute the phase angle between a periodic component and a detector array from samples taken at one, two, ten, and twenty degrees. More generally, the phase angle can be calculated using samples of the component taken at x, y, and z degrees as long as x, y, and z are all between zero and 360 degrees and as long as x, y, and z are three unique numbers (e.g., x can not equal z). Although computations of phase angles from such random samples are possible, the computations are generally complex, and it is generally preferred to use the computationally simple 4-bin algorithm.

Once the desired number of samples per period and the width of the photodetectors has been determined, the locations of the photodetectors on the array may then be determined. As discussed above in connection with array 300, when designing detector arrays according to the invention, the choice of photodetector width can make it inconvenient to locate the desired number of photodetectors within a region no larger than a single period of the component of interest. In general, if it is decided to use n samples per period, and if n times the photodetector width (measured in degrees of the component of interest) is greater than 360, then it is more convenient exploit the periodicity of the component of interest and to locate the n photodetectors in a region wider than a single period of the component of interest.

For example, if it was desired to (1) use photodetectors that are 120 degrees wide and (2) to use four samples per period, then a detector array could be constructed according to the invention by locating photodetectors at zero, 120, 240, and 460 degrees. Such photodetectors would provide a non-degenerate set of four samples. Additional groups of similarly situated photodetectors (e.g., at 720, 840, 960, 1080) could also be included in the array. Such additional groups provide samples degenerate of those provided by the first group. Although such degenerate samples do not add information, they do boost the signal to noise ratio for the array. Although such detector array designs are embraced by the invention, the associated processing circuitry needed to compute the phase angle from such an array is relatively complex. To simplify such associated processing circuitry, it is preferred to place the photodetectors at locations that permit their measurements to be used with the mathematically simple 4-bin algorithm.

FIGS. 1A-1D and 6 may be used to contrast prior art detector arrays with detector arrays constructed according to the invention. Referring again to FIGS. 1A-1D, in array 20, each period of component 10 is measured by a group of four detectors. The array 20 includes more than four detectors, where each group of four (1) provides four non-degenerate samples taken within a single period of component 10 and (2) duplicates, or is redundant with respect to, the samples provided by each other group of four detectors.

Referring to FIG. 6, the photodetectors in array 600 are arranged in groups of four for use with the 4-bin algorithm. Each group of four includes photodetectors 601, 602, 603, 604. Each group of four adjacent photodetectors, such as group 610, provides four non-degenerate samples of component 10: detector 601 provides a sample at zero degrees, detector 602 provides a sample at 90 (i.e., 90+2*360) degrees, detector 603 provides a sample at 180 (i.e., 180+360) degrees, and detector 604 provides a sample at 270 (i.e., 270+0*360) degrees. In prior art detector array 20 (FIGS. 1A-1D), detectors 32, 34, 36, and 38 similarly provide samples at zero, 90, 180, and 270 degrees. However, in prior art detector array 20, the width of an adjacent group of detectors 32, 34, 36, 38 is no wider than a single period of component 10. In detector array 600, in contrast to the prior art, the width of each group of four adjacent detectors is larger than a single period of component 10. For example, the four detectors in group 610 span almost two and a half periods of component 10. In general, in detector arrays constructed according to the invention for use with the n-bin algorithm, the width of each detector is selected so as to filter out a desired component. If that width makes it impractical to locate n detectors in a region no wider than a single period of the component of interest, then the periodicity of that component is preferably exploited and the n detectors are located in a region wider than one or more periods of the component of interest so as to provide samples that are substantially equivalent to n non-degenerate samples taken within a single period.

Referring to FIG. 6, the four photodetectors in group 610 provide four non-degenerate samples of component 10. Each other group of four photodetectors provides samples that are degenerate of the samples provided by group 610. Inclusion of the extra degenerate samples generally increases the signal-to-noise ratio in the detector array. Provision of a set of non-degenerate samples by each group insures that it is mathematically possible to calculate the phase angle between the component 10 and the detector array.

FIG. 7 illustrates another detector array 700 constructed according to the invention. As with array 300, array 700 is configured to detect the phase angle between the array 700 and an incident periodic component (shown as 750 in FIG. 7) while also filtering out contribution of a harmonic component that has three times the frequency of component 750. As with array 300, all photodetectors in array 700 are characterized by a width W that is substantially equal to one third the period of component 750 (T/3) (which is equal to the period of the harmonic component to be suppressed). Also, array 700 is configured for use with the 4-bin algorithm.

In array 700 the photodetectors are arranged into groups of four. Two groups of four 710, 720 are shown in FIG. 7, and these two groups 710, 720 form a set 730. Additional sets may of course be included in array 700 and would be located to the right of the set 730 shown in FIG. 7. Within each group, the four photodetectors provide four non-degenerate samples of component 750. Specifically, in group 710, detector D₀ provides a sample at zero degrees, detector D₁ provides a sample at 90 (i.e., 90+360=450) degrees, detector D₂ provides a sample at 180 degrees, and detector D₃ provides a sample at 270 (i.e., 270+360=630) degrees. In group 720, detector D₀ provides a sample at zero degrees (i.e., zero+3*360=1080), detector D₁ provides a sample at 90 (i.e., 90+4*360=1530) degrees, detector D₂ provides a sample at 180 degrees (i.e., 180+2*360=900), and detector D₃ provides a sample at 270 (i.e., 270+3*360=1350) degrees. So, the detectors in each group provide four non-degenerate samples at zero, 90, 180, and 270 degrees, which, as discussed above, may be used according to the 4-bin algorithm to calculate the phase angle between array 700 and component 750.

Detector array 700 may be more complex to manufacture than array 300 because the spacing between the photodetectors is not constant. However, detector array 700 is more compact than array 300. In array 300 the space between the left edges of two adjacent groups of four photodetectors is substantially equal to 1080 degrees, whereas in array 700 that space is substantially equal to only 900 degrees. So, array 700 is more efficient in its use of incident light.

As shown in FIG. 7, it is generally possible to configure the photodetectors of a detector array constructed according to the invention into groups and to further configure the groups into sets. In general, each “group” of photodetectors provides n non-degenerate samples, and each “set” is a collection of two or more groups. The “set” defines a unit that may be periodically repeated on the array. For example, array 700 may include several sets 730. Each of the sets 730 would be substantially identical and would be periodically placed to the left of the set 730 shown in FIG. 7. The first detector of a set disposed adjacent to the set 730 shown in FIG. 7 (i.e., the D₀ photodetector of the next group 710), would start at 1800 degrees.

FIG. 8 illustrates another detector array 800 constructed according to the invention. As with arrays 300 and 700, array 800 is configured to detect the phase angle between the array 800 and an incident periodic component (shown as 850 in FIG. 8) while also filtering out contribution of a harmonic component that has three times the frequency of component 850. As with arrays 300 and 700, all photodetectors in array 800 are characterized by a width W that is substantially equal to one third the period of component 850 (T/3) (which is equal to the period of the harmonic component to be suppressed). Also, array 800 is configured for use with the 4-bin algorithm.

In array 800 the photodetectors are arranged into groups of four. Two groups of four 810, 820 are shown in FIG. 8, and these two groups form a set 830. Additional sets 830 may of course be included in array 800 and would be disposed to the right of the set shown in FIG. 8. Group 820 includes the four detectors D₀, D₁, D₂, and D₃, which are shown as cross-hatched in FIG. 8. Group 810 includes the remaining four detectors (i.e., the detectors which are not cross-hatched in FIG. 8). The photodetectors in each group 810, 820 provide four non-degenerate samples of component 850. Specifically, in group 810, detector D₀ provides a sample at zero degrees, detector D₁ provides a sample at 90 (i.e., 90+2*360=930) degrees, detector D₂ provides a sample at 180 degrees (i.e., 180+360=540), and detector D₃ provides a sample at 270 degrees. In group 820, detector D₀ provides a sample at minus 30 degrees (i.e., !30+2*360=690), detector D₁ provides a sample at 60 (i.e., 60+360=420) degrees, detector D₂ provides a sample at 150 degrees, and detector D₃ provides a sample at 240 (i.e., 240+2*360=960) degrees. So, photodetectors in group 810 provide samples at zero, 90, 180, and 270 degrees, whereas photodetectors in group 820 provide samples at minus 30, 60, 150, and 240 degrees.

In array 300, the output terminals of all the D₀ detectors in the array were electrically connected to a pad P₀ (shown explicitly in FIG. 3) so as to effectively sum the analog output signals generated by all the D₀ detectors, and the D₁, D₂, and D₃ detectors were of course treated similarly. One way to process the signals generated by array 800 would be to use eight such output pads instead of four (i.e., instead of the four used in array 300). In such an embodiment, the D₀, D₁, D₂, and D₃ detectors in the groups 810 would be electrically connected to four output pads P₀, P₁, P₂, and P₃, respectively, and the D₀, D₁, D₂, and D₃ detectors in the groups 820 would be electrically connected to four output pads P₄, P₅, P₆, and P₇, respectively. In such an embodiment, the analog signals on pads P₀, P₁, P₂, P₃, P₄, P₅, P₆, and P₇, would represent the sum of all samples taken at zero, 90, 180, 270, minus 30, 60, 150, and 240 degrees, respectively. Processing circuitry could use these signals to calculate the phase angle between the array 800 and the component 850.

In a different embodiment, array 800 may include only four output pads P₀, P₁, P₂, and P₃. In this embodiment, the output terminals of all the D₀ photodetectors, regardless of whether the photodetectors are located in a group 810 or a group 820, are all electrically connected to pad P₀. Similarly, the output terminals of all the D₁, D₂, and D₃ photodetectors (regardless of whether the photodetectors are located in a group 810 or a group 820) are all electrically connected to pads P₁, P₂, and P₃, respectively. This embodiment effectively combines measurements taken at zero and minus 30 degrees (i.e., by electrically connecting Do photodetectors from groups 810 and 820). Similarly, this embodiment effectively combines (1) measurements taken at 90 and 60 degrees (i.e., by electrically connecting D₁ photodetectors from groups 810 and 820); (2) measurements taken at 180 and 150 degrees (i.e., by electrically connecting D₂ photodetectors from groups 810 and 820); and (3) measurements taken at 270 and 240 degrees (i.e., by electrically connecting D₃ photodetectors from groups 810 and 820). As discussed below, these combined measurements may be readily used by the 4-bin algorithm.

In such an embodiment, the analog signals S₀, S₁, S₂, and S₃, that will be present on the pads P₀, P₁, P₂, and P₃, respectively, are given by the following Equation (4).

$$\begin{matrix}{S}_{0} = m {\int }_{0}^{120} sin ( x ) ⅆ x + n {\int }_{30}^{90} sin ( x ) ⅆ x = m sin ( 60 ) + n sin ( 30 ) \\ {S}_{1} = m {\int }_{90}^{210} sin ( x ) ⅆ x + n {\int }_{60}^{180} sin ( x ) ⅆ x = m sin ( 150 ) + n sin ( 120 ) \\ {S}_{2} = m {\int }_{80}^{300} sin ( x ) ⅆ x + n {\int }_{50}^{270} sin ( x ) ⅆ x = m sin ( 240 ) + n sin ( 210 ) \\ {S}_{3} = m {\int }_{270}^{390} sin ( x ) ⅆ x + n {\int }_{240}^{360} sin ( x ) ⅆ x = m sin ( 330 ) + n sin ( 300 )\end{matrix} \qquad ( 4 )$$

if . . . m=n, . . . then

S₀=m[sin(60)+sin(30)]

S₁=m[sin(150)+sin(120)]

S₂=m[sin(240)+sin(210)]

S₃=m[sin(330)+sin(300)]

In the above Equation (4), m represents the number of groups 810 included in the array 800 and n represents the number of groups 820 included in the array. Normally, m is equal to n and the equations reduce to those shown in the bottom portion of Equation (4). In practice, the signals S₀, S₁, S₂, and S₃ will also include a constant offset (proportional to the uniform background) and some amount of noise, however, this offset and noise component is not represented in Equation (4) and may be ignored for this analysis of how to use the signals.

S₀, S₁, S₂, and S₃ are the inputs to Equation (1), which, as noted above, for the 4-bin algorithm reduces to Tan(P)=(S₀−S₂)/(S₁−S₃). As shown in Equation (4), each of the signals S₀, S₁, S₂, and S₃ is mathematically equivalent to a sum of the sines of two angles, and the angles are always separated by thirty degrees. The trigonometric identity shown in the following Equation (5) illustrates how these signals may be used.

sin(P)+sin(P−30)=2 sin(P−15)*cos(15)

cos(15)=0.966

so

sin(P)+sin(P−30)=1.932*sin(P−15) (5)

So, if the signals S₀, S₁, S₂, and S₃ are applied directly to the equation for the 4-bin algorithm Tan(P)=(S₀−S₂)/(S₁−S₃), the angle calculated by that equation will simply be the actual phase angle between the periodic component and the detector array offset by fifteen degrees. The scalar factor 1.932 represents the amount by which signal strength is boosted by adding signals from groups 810 and 820 together.

Although the design of detector array 800 is more complex than that of array 300, array 800 utilizes light incident on the array more efficiently. The dead spaces are advantageously almost entirely eliminated from array 800.

Like array 700 (shown in FIG. 7), array 800 may include a plurality of sets and each of the sets includes two groups of photodetectors. However, unlike array 700, in array 800 the photodetectors in a first group are interleaved with the photodetectors of a second group when the first and second groups are in the same set. It will be appreciated that such interleaving allows creation of a highly compact detector array. The first detector of a set disposed adjacent to the set 830 shown in FIG. 8 (i.e., the D₀ photodetector of the next group 810), would start at 1080 degrees.

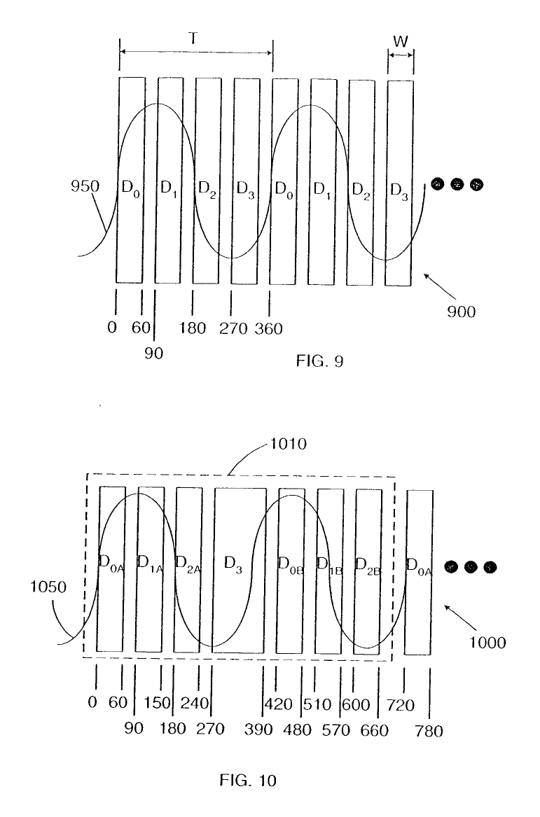

FIG. 9 illustrates yet another detector array 900 constructed according to the invention. Array 900 is configured to detect the phase angle between the array 900 and an incident periodic component (shown as 950 in FIG. 9) while also filtering out contribution of a harmonic component that has six times the frequency of component 950. To filter out contribution of the sixth harmonic component, the widths W of all the detectors in array 900 are set to be substantially equal to sixty degrees (or one sixth the period T of component 950).

Array 900 is configured for use with the 4-bin algorithm. The photodetectors are arranged into groups of four, each group including photodetectors D₀, D₁, D₂, and D₃. Within each group, the photodetectors D₀, D₁, D₂, and D₃, provide four non-degenerate samples at zero, 90, 180, and 270 degrees. Since the widths of the photodetectors in array 900 are only equal to sixty degrees, it is possible to locate an entire group of photodetectors D₀, D₁, D₂, and D₃ into a region no larger than a single period of component 950 (i.e., since 60*4<360).

FIG. 10 shows another detector array 1000 constructed according to the invention. Array 1000 is configured to detect the phase angle between the array 1000 and an incident periodic component (shown as 1050 in FIG. 10) while also filtering out contribution of a harmonic component that has three times the frequency of component 1050. As with arrays 300 and 700, array 1000 is configured for use with the 4-bin algorithm.

In array 1000, the photodetectors are configured into groups 1010, one of which is shown in FIG. 10. Each group 1010 includes seven photodetectors, D_{0A}, D_{0B}, D_{1A}, D_{1B}, D_{2A}, D_{2B}, and D₃. The signal S₀ is formed by summing all the D_{0A} and D_{0B} photodetectors in the array 1000; the signal S₁ is formed by summing all the D_{1A} and D_{1B} photodetectors in the array 1000; the signal S₂ is formed by summing all the D_{2A} and D_{2B} photodetectors in the array 1000; and the signal S₃ is formed by summing all the D₃ photodetectors in the array 1000.

The photodetector D_{0A} provides a sample that extends from zero to sixty degrees. The photodetector D_{0B} provides a sample that extends from sixty to 120 degrees (i.e., 420=60+360 and 480=120+360). So, summing the outputs of the DOA and DOB photodetectors effectively provides a sample that extends from zero to 120 degrees. The photodetector D_{1A} provides a sample that extends from ninety to 150 degrees. The photodetector D_{1B} provides a sample that extends from 150 to 210 degrees (i.e., 510=150+360 and 570=210+360). So, summing the outputs of the D_{1A} and D_{1B} photodetectors effectively provides a sample that extends from ninety to 210 degrees. The photodetector D_{2A} provides a sample that extends from 180 to 240 degrees. The photodetector D_{2B} provides a sample that extends from 240 to 300 degrees (i.e., 600=240+360 and 660=300+360). So, summing the outputs of the D_{2A} and D_{2B} photodetectors effectively provides a sample that extends from 180 to 300 degrees. Finally, the photodetector D₃ provides a sample that extends from 270 to 390 degrees.

In other words, summing the D_{0A} and D_{0B} photodetectors effectively provides a sample that is 120 degrees wide and begins at zero degrees; summing the D_{1A} and D_{1B} photodetectors effectively provides a sample that is 120 degrees wide and begins at ninety degrees; summing the D_{2A} and D_{2B} photodetectors effectively provides a sample that is 120 degrees wide and begins at 180 degrees; and the photodetector D₃ provides a sample that is 120 degrees wide and begins at 270 degrees. So, group 1010 uses seven photodetectors to provide the four samples used by the 4-bin algorithm. Also, since each of those samples is 120 degrees wide, array 1010 suppresses contribution of the third harmonic of component 1050. One of the samples (i.e., the one at 270 degrees) is provided by the single D₃ photodetector. The remaining three samples (i.e., the ones at 0, 90, and 180 degrees) are each provided by summing the outputs of two photodetectors.

One group 1010 is shown in FIG. 10. Additional groups could of course be provided to the right of the illustrated group 1010. The D_{0A} photodetector shown at the right end of FIG. 10 marks the beginning of another such group. It will be appreciated that array 1000 is another very compact array that provides suppression of the third harmonic. It will also be appreciated that while in array 1000 some of the non-degenerate samples are generated by summing the outputs generated by two photodetectors, in other arrays constructed according to the invention, some of the non-degenerate samples could be generated by summing the outputs generated by two or more of the photodetectors.

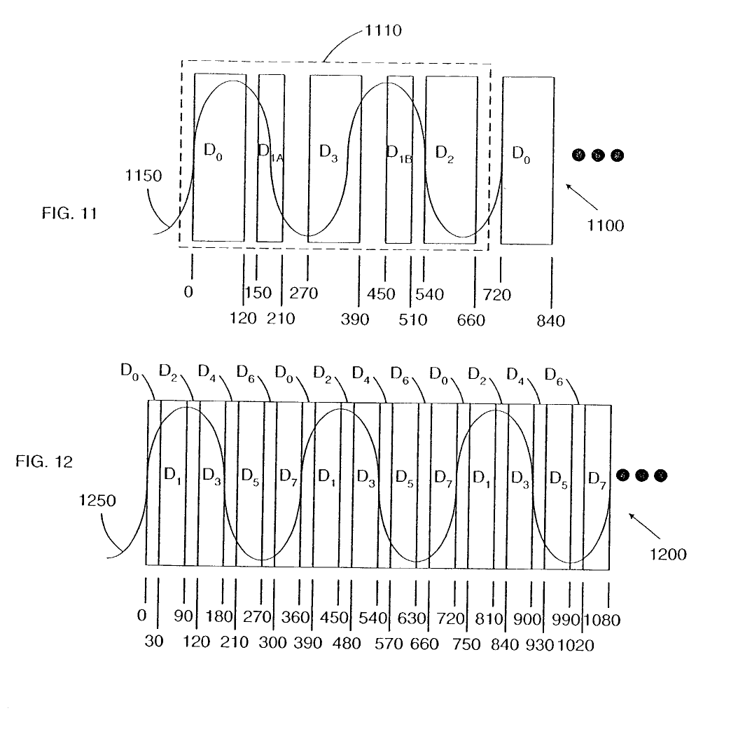

FIG. 11 shows yet another detector array 1100 constructed according to the invention. Array 1100 is configured to detect the phase angle between the array 1100 and an incident periodic component (shown as 1150 in FIG. 11) while also filtering out contribution of a harmonic component that has three times the frequency of component 1150. As with arrays 300, 700, and 1000, array 100 is configured for use with the 4-bin algorithm.

In array 1100, the photodetectors are configured into groups 1110, one of which is shown in FIG. 11. Each group 1110 includes five photodetectors, D₀, D_{1A}, D_{1B}, D₂, and D₃. The signal S₀ is formed by summing all the D₀ photodetectors in the array 1100; the signal S₁ is formed by summing all the D_{1A} and D_{1B} photodetectors in the array 1100; the signal S₂ is formed by summing all the D₂ photodetectors in the array 1100; and the signal S₃ is formed by summing all the D₃ photodetectors in the array 1100.

The photodetector D₀ provides a sample that extends from zero to 120 degrees. The photodetector D_{1B} provides a sample that extends from ninety to 150 degrees (i.e., 450=90+360 and 510=150+360). The photodetector D_{1A} provides a sample that extends from 150 to 210 degrees. So, summing the outputs of the D_{1A} and D_{1B} photodetectors effectively provides a sample that extends from ninety to 210 degrees. The photodetector D₂ provides a sample that extends from 180 to 300 degrees (i.e., 540=180+360 and 660=300+360). Finally, the photodetector D₃ provides a sample that extends from 270 to 390 degrees.

In other words, the D₀ photodetector provides a sample that is 120 degrees wide and begins at zero degrees; summing the D_{1A} and D_{1B} photodetectors effectively provides a sample that is 120 degrees wide and begins at ninety degrees; the D₂ photodetector provides a sample that is 120 degrees wide and begins at 180 degrees; and the D₃ photodetector provides a sample that is 120 degrees wide and begins at 270 degrees. So, group 1110 uses five photodetectors to provide the four samples used by the 4-bin algorithm. Also, since each of those samples is 120 degrees wide, array 1100 suppresses contribution of the third harmonic of component 1150. Three of the samples (i.e., the ones at zero, 180, and 270 degrees) are provided by the single D₀, D₂, and D₃ photodetectors. The remaining sample (i.e., the one at 90 degrees) is provided by summing the outputs of two photodetectors.

One group 1110 is shown in FIG. 11. Additional groups could of course be provided to the right of the illustrated group 1110. The D₀ photodetector shown at the right end of FIG. 11 marks the beginning of another such group. It will be appreciated that array 1100 is another very compact array that provides suppression of the third harmonic. It will further be appreciated that arrays 1000 and 1100 (FIGS. 10 and 11) are very similar. In array 1000 (FIG. 10), one of the non-degenerate samples in each group is provided by a single photodetector, and the remaining three non-degenerate samples are provided by summing outputs of different detectors, whereas in array 1100 (FIG. 11), only one of the non-degenerate samples in each group is provided by summing outputs of different detectors.

FIG. 12 shows still another detector array 1200 constructed according to the invention. Array 1200 is configured to detect the phase angle between the array 1200 and an incident periodic component (shown as 1250 in FIG. 12) while also filtering out contribution of a harmonic component that has three times the frequency of component 1250. As with arrays 300, 700, 1000, and array 1100, array 1200 is configured for use with the 4-bin algorithm.

In array 1200, the photodetectors are configured into sets, three of which are shown in FIG. 12. Additional sets could of course be included and would be disposed to the right of those shown in FIG. 12. Each set includes eight photodetectors D₀, D₁, D₂, D₃, D₄, D₅, D₆, and D₇. The signal S₀ is formed by combining the outputs of all the D₀, D₁, and D₂, photodetectors in the array 1200; the signal Si is formed by combining the outputs of all the D₂, D₃, and D₄, photodetectors in the array 1200; the signal S₂ is formed by combining the outputs of all the D₄, D₅, and D₆, photodetectors in the array 1200; and the signal S₃ is formed by combining the outputs of all the D₆, D₇, and D₀, photodetectors in the array 1200.

In the first set of eight detectors at the left end of array 1200 as shown in FIG. 12, the collection of photodetectors D₀, D₁, and D₂, provide a sample that is 120 degrees wide and is located at zero degrees (i.e., the sample extends from zero to 120 degrees); the collection of photodetectors D₂, D₃, and D₄, provide a sample that is 120 degrees wide and is located at 90 degrees (i.e., the sample extends from 90 to 210 degrees); the collection of photodetectors D₄, D₅, and D₆, provide a sample that is 120 degrees wide and is located at 180 degrees (i.e., the sample extends from 180 to 300 degrees); and the collection of photodetectors D₆, D₇, and D₀, provide a sample that is 120 degrees wide and is located at 270 degrees (i.e., the sample extends from 270 to 390 degrees; note that the D₀ detector contributing to this sample extends from 360 to 390 degrees and is actually part of the second set of detectors in the array). S₀ as with the other arrays 300, 700, 1000, and array 1100, array 1200 provides samples that are 120 degrees wide (i.e., for suppressing effects of the third harmonic) and are located appropriately for use with the 4-bin algorithm.

In array 1200, although each set includes eight photodetectors (i.e., D₀, D₁, D₂, D₃, D₄, D₅, D₆, and D₇), nine photodetectors are actually used to generate the four non-degenerate samples used by the N-bin algorithm. That is, the eight photodetectors of one set plus the Do photodetector of the adjacent set are used to generate a single set of four non-degenerate samples. So, in array 1200, a set of four non-degenerate samples are generated by photodetectors that extend over 390 degrees (i.e., just 30 degrees larger than a single period). Accordingly, array 1200 is advantageously very compact.

Unlike the arrays 300, 700, 1000, and 1100, in array 1200 the photodetectors are essentially overlapping. That is, in array 1200, a single photodetector is used to generate more than one of the signals S₀, S₁, S₂, and S₃. For example, the photodetector D₂ is used to form both of the S₀ and S₁ signals. All of the even photodetectors (i.e., D₀, D₂, D₄, and D₆) contribute to forming two of the signals S₀, S₁, S₂, and S₃, whereas the odd photodetectors (i.e., D₁, D₃, and D₅) contribute to only one of the signals S₀, S₁, S₂, and S₃. Also, the dead space between adjacent photodetectors is eliminated in array 1200.

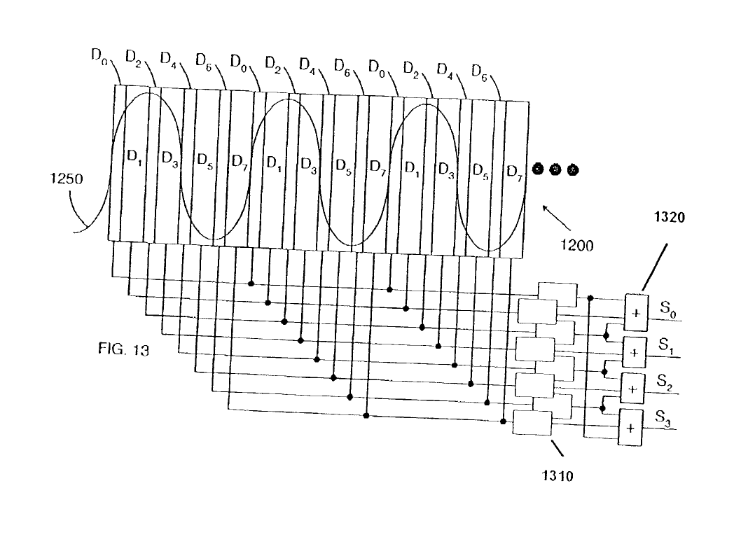

Depending on how the signals S₀, S₁, S₂, and S₃ are generated, it may be important to account for the overlapping nature of array 1200 when generating those signals. FIG. 13 illustrates an example of analog circuitry that may be used to generate the signals S₀, S₁, S₂, and S₃, directly from the analog output signals generated by the photodetectors of array 1200. As shown in FIG. 13, a current-to-voltage amplifier 1310 is located on each output signal line to prepare the signals for the summing amplifiers 1320 which follow. Output signals from the current-to-voltage amplifiers on the lines from the even photodetectors (i.e., D₀, D₂, D₄, and D₆) are directed to two summing amplifiers, since each even detector contributes to two of the four bin signals. These even detector signals are summed with one of the odd detector signals in the summing amplifiers 1320 to generate the signals S₀, S₁, S₂, and S₃. The following Equation (6) also describes how the signals S₀, S₁, S₂, and S₃, which are used as inputs to the 4-bin algorithm, may be generated by the analog circuitry shown in FIG. 13.

S₀=D₀+D₁+D₂

S₁=D₂+D₃+D₄

S₂=D₄+D₅+D₆

S₃=D₆+D₇+D₀ (6)

In Equation (6), the terms D₀, D₁, D₂, D₃, D₄, D₅, D₆, and D₇, represent the analog output signals generated by the corresponding photodetectors in array 1200 (e.g., in Equation (6), the term “D₀” represents the sum of all the analog output signals generated by all of the D₀ photodetectors in array 1200).

It will be appreciated that while FIG. 13 and Equation (6) illustrate analog processing that may be used to generate the signals S₀, S₁, S₂, and S₃, those signals may alternatively be generated digitally. For example, the analog outputs generated by the photodetectors D₀, D₁, D₂, D₃, D₄, D₅, D₆, and D₇, may be electrically connected to eight output pads P₀, P₁, P₂, P₃, P₄, P₅, P₆, and P₇, respectively (so, for example, the signal on pad P₀ would represent the analog sum of all of the D₀ photodetectors in array 1200). Digital processing circuitry could then generate digital representations of the signals on the output pads (e.g., by using one or more analog-to-digital converters). The signals S₀, S₁, S₂, and S₃ could then be calculated digitally according to the following Equation (7).

S₀=PD₀+PD₁+PD₂

S₁=PD₂+PD₃+PD₄

S₂=PD₄+PD₅+PD₆

S₃=PD₆+PD₇+PD₀ (7)

In Equation (7), the terms PDₙ represent the digital values of the signals on the pads Pₙ, for all values of n from zero to seven. It will be appreciated that generating the signals S₀, S₁, S₂, and S₃ digitally, obviates the need for using times two amplifiers.

In array 1200, each of the photodetectors is either thirty or sixty degrees wide (e.g., D₀ is thirty degrees wide whereas D₁ is sixty degrees wide). It will be appreciated that other arrays may be constructed according to the invention that are similar to array 1200 in which the photodetectors are of a different size. For example, a detector array may be constructed according to the invention in which all of the photodetectors are ten degrees wide (i.e., an array of photodetectors that are all ten degrees wide with detectors located at zero degrees, ten degrees, twenty degrees, etc.). If it were desired to construct the array so that it was insensitive to the third order harmonic, then samples that are 120 degrees wide could be formed by summing appropriate groups of twelve detectors.

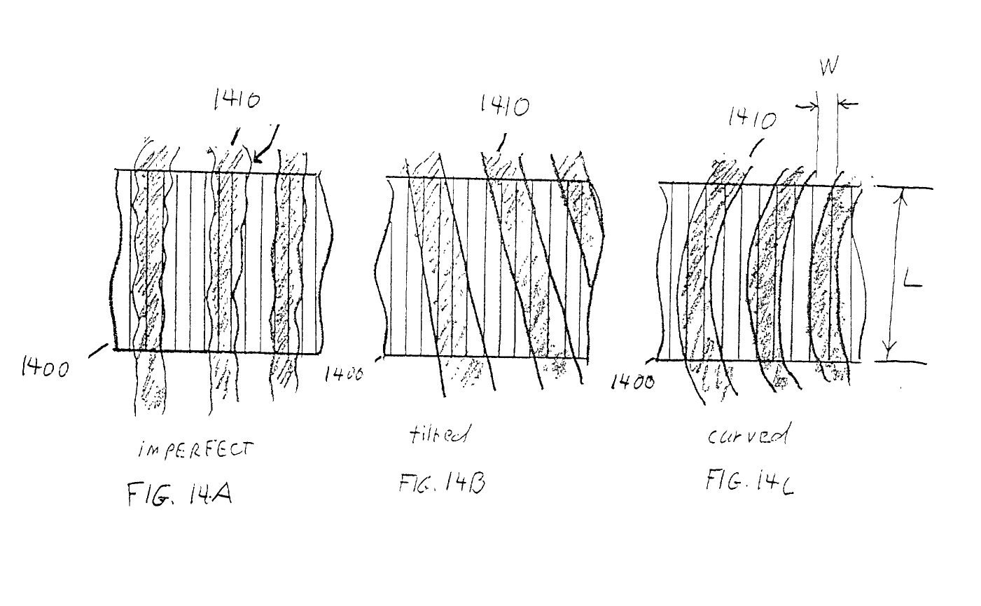

The selection of the widths W of photodetectors in arrays constructed according to the invention has been discussed extensively above. Several criteria may be used to select the lengths L of photodetectors (e.g., as shown in FIG. 3) in the array. One preferred method is to select the length L so that length to width aspect ratio is equal to about 1.5:1. In general, the selection of the photodetector length L is a compromise between light gathering efficiency, noise suppression, alignment sensitivity, and loss of contrast. FIGS. 14A-14C illustrate three different fringe patterns incident on an array 1400. In FIGS. 14A-14C, the shaded regions 1410 represent peaks of intensity of the incident fringe patterns. As indicated, the photodetectors of the array are oriented so that their long dimension (i.e., their length L) is generally parallel to the direction in which the fringes are nominally constant. Increasing the photodetector length L advantageously allows each photodetector to collect more light and allows the photodetectors to average imperfections/non-uniformities in the fringes. However, increasing photodetector length L also disadvantageously increases alignment tolerances in the array and reduces contrast with tilted or curved fringes as shown in FIGS. 14B-14C.

It will be appreciated that detector arrays configured according to the invention may be manufactured using customary processing techniques. Use of conventional photolithographic techniques permits precise definition of the width, length, and location of the photodetectors on the array. The arrays are preferably constructed so that all photodetectors on an array are characterized by similar optical performance. If photodetectors on an array provide different optical performance, then spurious signals may be created when a uniform fringe moves across the non-uniform photodetectors. Uniform properties are most readily achieved when all of the photodetectors are formed simultaneously on a common substrate.

Additionally, the detector arrays are preferably manufactured using techniques for rendering the non-active, or “dead”, regions of the substrate truly insensitive to light. The inventors have determined that foundries that are capable of applying an optically-opaque blocking covering the entire top surface of the substrate, save for the active sensing regions, are able to achieve this preferred configuration. The blocking covering, or layer, may be formed from, for example, aluminum or a combination of titanium and tungsten.

It will further be appreciated that additional detector arrays, of similar or different layouts, may be manufactured on the same substrate as a detector array configured according to the invention, without detrimental effects on the inventive array. It will be appreciated that sharing a single substrate between multiple arrays may benefit optical instruments that require multiple detector arrays in close proximity and/or with precision relative alignment.

The selection of materials used to construct the array generally depends on the wavelength of light that will be incident on the array. For example, for operation in the visible and near infrared, the substrate for the array may be implemented using silicon. Similarly, for example, a material such as germanium could be used if infrared operation were desired.

The invention has been discussed above primarily in terms of constructing arrays that filter out contribution of a higher order harmonic component of the component of interest. However, it will be appreciated that the invention may be used to construct an array that filters out contribution of virtually any periodic component. For example, in an optical encoder that monitors a fringe pattern, a periodic source of noise that is not a multiple of the fringe pattern of interest may be generated by incoherent light passing through the grating. Detector arrays constructed according to the invention may filter out this type, or any other type, of periodic noise simply by setting the widths of the photodetectors substantially equal to the period or integer multiples of the period of the periodic noise signal.

Since certain changes may be made in the above apparatus without departing from the scope of the invention herein involved, it is intended that all matter contained in the above description or shown in the accompanying drawing shall be interpreted in an illustrative and not a limiting sense.

What is claimed is:

1. A detector array for monitoring a signal, the signal including a first periodic component and a second periodic component, the second periodic component being characterized by a period T, the detector array including a plurality of photodetectors, each of the photodetectors being characterized by a length and a width, the width of each photodetector being substantially equal to an integer multiple of T.

2. A detector array according to claim 1, wherein the widths of all photodetectors in the array are substantially equal.

3. A detector array according to claim 1, wherein the widths of all photodetectors in the array are substantially equal to T.

4. A detector array according to claim 1, wherein at least one photodetector in the array is characterized by a width substantially equal to nT and at least one other photodetector in the array is characterized by a width substantially equal to mT, n and m being unequal integers.

5. A detector array according to claim 4, wherein n is equal to one.

6. A detector array according to claim 1, the detector array including at least one group of photodetectors, each of the groups including n photodetectors, n being an integer, the n photodetectors in each of the groups providing n non-degenerate samples of the first periodic component.

7. A detector array according to claim 6, the n detectors in each of the groups being disposed in a region wider than a single period of the first periodic component.

8. A detector array according to claim 6, wherein n equals four.

9. A detector array according to claim 8, the first periodic component being characterized by a period TI, the period of the second periodic component T being substantially equal to one third of the period TI.

10. A detector array according to claim 9, the widths of all the photodetectors being substantially equal to the period of the second periodic component T.

11. A detector array according to claim 10, each group including a first detector, a second detector, a third detector, and a fourth detector, a distance between a center of the first detector and a center of the second detector being substantially equal to three fourths of the period T1, a distance between the center of the first detector and a center of the third detector being substantially equal to one and a half times the period T1, a distance between the center of the first detector and a center of the fourth detector being substantially equal to two and one fourth times the period T1.

12. A detector array according to claim 11, a distance between the centers of the first detectors in adjacent groups of detectors being substantially equal to three times the period T1.

13. A detector array for monitoring an optical signal, the optical signal including at least one periodic component, the detector array including at least one group of photodetectors, each of the groups including n photodetectors, n being an integer, the n photodetectors in each of the groups providing n non-degenerate samples of the periodic component, the n detectors in each group being disposed in a region wider than a single period of the periodic component.

14. A detector array for monitoring an optical signal, the optical signal including a first periodic component and a second periodic component, the second periodic component being characterized by a period T, the detector array including at least one group of photodetectors, each of the groups including n photodetectors, n being an integer, the n photodetectors in each of the groups being disposed so as to provide n non-degenerate samples of the first periodic component, the n detectors in each of the groups being disposed in a region wider than a single period of the first periodic component, each of the photodetectors in the array being characterized by a length and a width, the width of each photodetector in the array being substantially equal to an integer multiple of T.

15. A detector array for monitoring an optical signal, the optical signal including at least one periodic component, the detector array including at least one set of photodetectors, each of the sets including two groups of photodetectors, each of the groups including n photodetectors, n being an integer, the photodetectors in a single set being disposed to provide 2n non-degenerate samples of the periodic component, the photodetectors in the single set being disposed in a region wider than two periods of the periodic component.

16. A detector array for monitoring a signal, the signal including a first periodic component and a second periodic component, the second periodic component being characterized by a period T, the detector array including a plurality of photodetectors, each of the photodetectors generating an output signal, the output signals providing a set of n non-degenerate samples of the first periodic component, each of the samples being characterized by a width substantially equal to an integer multiple of T, at least one of the samples being generated by summing two or more of the output signals.

17. A detector array for monitoring an optical signal, the optical signal including at least one periodic component, the detector array including at least one group of photodetectors, each of the photodetectors in the at least one group generating an output signal, the output signals generated by the photodetectors in the at least one group providing a set of n non-degenerate samples of the at least one periodic component, at least one of the samples being generated by summing two or more of the output signals, the photodetectors in the at least one group being disposed in a region wider than a single period of the periodic component.

18. An optical encoder, including:
A. a light source;
B. a diffraction grating, the grating defining a plurality of reflective regions and a plurality of transmissive regions, a width of the reflective regions being substantially equal to a width of the transmissive regions, light emitted by the source and diffracted by the diffraction grating generating a first order fringe pattern and a third order fringe pattern, the first order fringe pattern being characterized by a period substantially equal to T, the third order fringe pattern being characterized by a period substantially equal to T/3; and
C. a detector array including a plurality of photodetectors, each of the photodetectors being characterized by a length and a width, the width of the photodetector being substantially equal to n times the period T/3 of the third order fringe pattern, n being an integer.

19. An encoder according to claim 18, n being equal to one.
